(19) United States
(12) Patent Application Publication
(10) Pub. No.: US 2016/0004789 A1
(43) Pub. Date: Jan. 7, 2016

(54) Visual Search Engine

(71) Applicant: Cherif Algreatly, Fremont, CA (US)

(72) Inventor: Cherif Algreatly, Fremont, CA (US)

(73) Assignee: Cherif Algreatly

(21) Appl. No.: 14/791,272

(22) Filed: Jul. 3, 2015

Related U.S. Application Data
(60) Provisional application No. 61/998,634, filed on Jul. 3, 2014.

(51) Int. Cl. G06F 17/30; G06K 9/00

(52) U.S. Cl. CPC G06F 17/30994; G06F 17/30259; G06F 17/30253; G06F 17/30864; G06F 17/30528; G06K 9/00288

(57) ABSTRACT

A method for sorting and searching images is disclosed. The method is utilized in various augmented reality applications to retrieve information related to the objects which appear in a picture taken by a camera. The objects can be human faces, text, 3D models or the like. The method can be used with mobile phones, tablets, or optical head mounted displays to serve numerous educational, gaming and commercial purposes.

### CROSS REFERENCE TO RELATED APPLICATIONS

This application claims the benefit of U.S. Provisional Application Ser. No. 61/998,634, filed Jul. 3, 2014.

### BACKGROUND

Traditional visual search engines are search engines designed to search for information on the World Wide Web through the input of an image. This information may consist of web pages, other images or online documents related to the image. This type of search engines is mostly used with mobile phones or computers. However, current visual search engines have certain usability limitations.

For example, a visual search engines such as GOOGLE SEARCH allows users to drag and drop a picture of an object into a search box to search for that chosen object. If this picture was taken by a user's camera, GOOGLE SEARCH does not retrieve accurate search results regarding the object, despite similar pictures of the object existing online. This limitation prevents people from using online visual search engines to search for faces, buildings or objects that appear in the pictures they take with their cameras and find accurate results. Regardless of the advances in modern visual search engines, the pictures taken by digital cameras are unsearchable.

Moreover, any user of the current available virtual search engines cannot use a picture of a book page, magazine article or a newspaper column to access additional related online information avalable for each of the examples mentioned. Therefore, printed materials remain separated from their relevant information on the Internet. Such a restriction in using current available search engines renders them useless with printed books, magazine, newspapers, and similar educational material.

In fact, the aforementioned limitations or restrictions of current visual search engines are a real problem that requires an innovative solution. The proposed solution could enhance the real time information that a user can access in regards to most objects they take pictures of; whether it's at work, school, or even at a supermarket, thus, creating hundreds of innovative educational, gaming and commercial applications.

### SUMMARY

In one embodiment, the present invention discloses a method for sorting and searching images through using a new technique. The method retrieves accurate search results when used with pictures taken by digital cameras, regardless of the position of the user relative to the objects that appear in the picture. This allows the user to access real time information regarding the objects they view when using mobile phone or optical head mounted display in the form of eye glasses. The objects can be human faces, buildings, machines, vehicles or objects as such. Accordingly, the present invention is utilized in various augmented reality applications by linking the objects located in front of the user to the online data related to these objects.

In another embodiment, the present invention is used with printed books, magazines or newspapers to link the content of the printed materials with digital data available on the Internet such as videos, pictures and other information. The user can use a mobile phone or tablet camera to view the printed book, magazine or newspaper, from any point of view. They are then able to see additional digital data presented on the mobile phone or tablet display related to the book page, magazine article or newspaper part they are viewing. In such cases, the content of the printed materials does not have to be fully clear on the mobile phone or tablet display, as it will be described subsequently.

In one embodiment, the present invention is used in video search to locate a certain video in a database using a frame image of the video. In this case, the search result indicates the video of the search image and the frame time of the search image in the video. In yet another embodiment, the present invention is utilized with three-dimensional objects or models to detect the identity of the three-dimensional objects or models from different points of view.

Overall, the above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF DRAWINGS

FIG. 1 illustrates an image of a page of a book, magazine or newspaper including text.

FIGS. 2 and 3 illustrate marking the boundaries of the text with polygons.

FIG. 4 illustrates an example of a database that stores a plurality of polygons representing text boundaries.

FIG. 5 illustrates marking the text lines with strips that start and end at the start and end of each text line.

FIG. 6 illustrates marking the text words with strips that start and end at the start and end of each word.

FIG. 7 illustrates an image of a book, magazine or newspaper page that includes pictures and text.

FIG. 8 illustrates marking the boundaries of the pictures and text with polygons.

FIG. 9 illustrates marking the pictures and text lines with horizontal strips.

FIG. 10 illustrates marking the pictures and text words with horizontal strips.

FIGS. 11 to 14 illustrate representing a picture of a human's face with a polygon.

FIGS. 15 to 17 illustrate representing a screenshot of a Web page with a plurality of polygons.

FIGS. 18 and 19 illustrate using the present invention in an augmented reality application with a magazine.

FIGS. 20 to 25 illustrate a search method for an image using a part of the image, according to one embodiment of the present invention.

FIG. 26 illustrates a 3D model and different positions of a computer virtual camera to take pictures of the 3D model from different points of view.

### DETAILED DESCRIPTION OF INVENTION

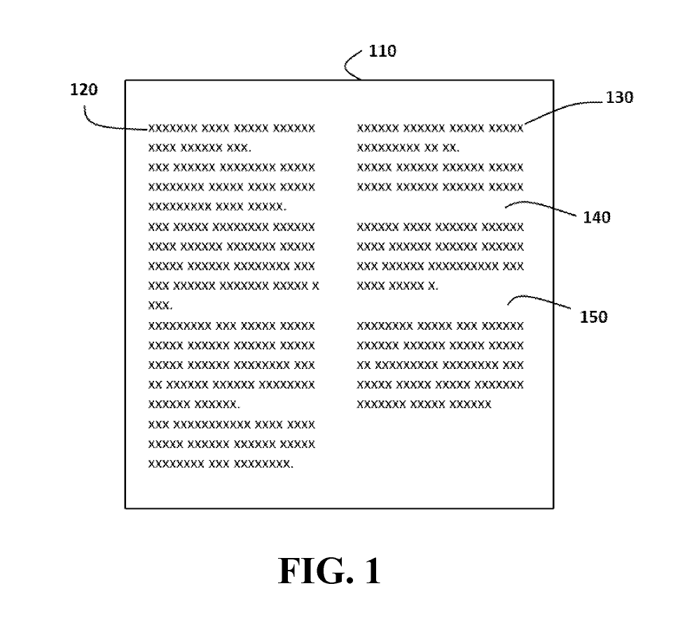

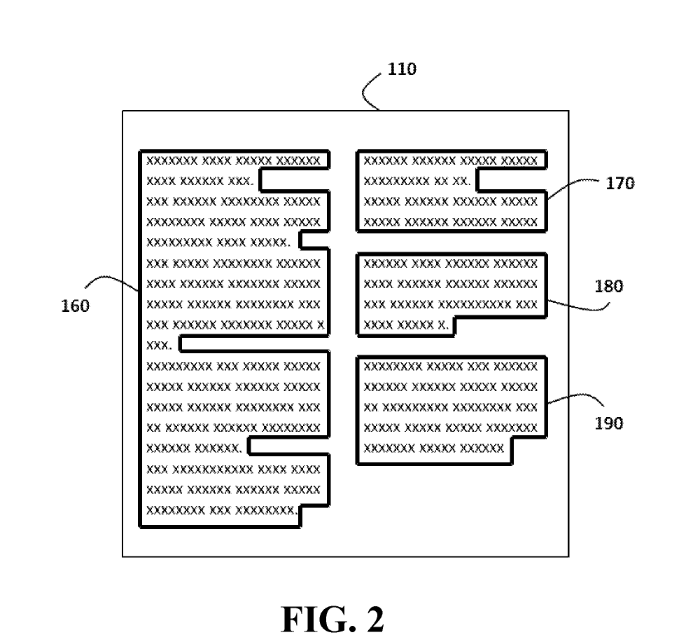

FIG. 1 illustrates a page 110 of a book, newspaper or magazine where a first text column 120 and a second text column 130 are located in this page. The first text column is comprised of one block where no empty lines are located between its paragraphs. The second text column is comprised of three blocks where two empty lines 140 and 150 are separating the three paragraphs of the column. FIG. 2 illustrates marking the block of the first text column with a polygon 160, and marking the three blocks of the second text column with three polygons 170-190 using a computer vision program. As shown in the figure, the lines of each polygon change according to the end of each text line of a paragraph.

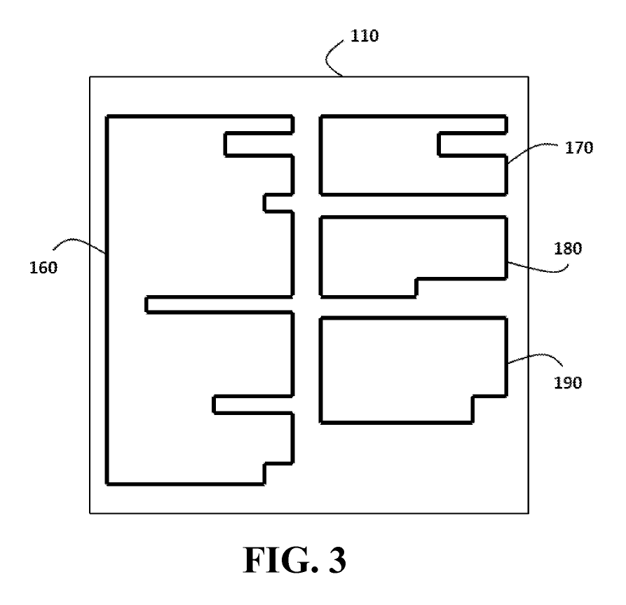

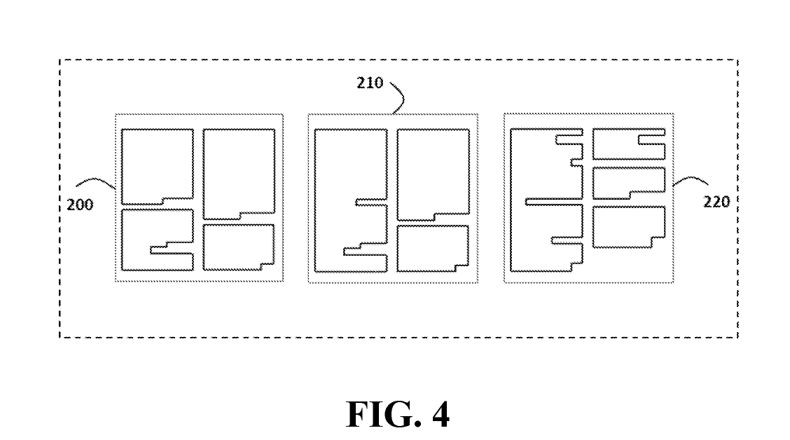

FIG. 3 illustrates the four polygons 160-190 of the page. According to one embodiment of the present invention, representing the text with such polygons simplifies searching for text images. For example, FIG. 4 illustrates three groups of polygons 200-220, stored in a database 230 to represent three text pages. Such a database allows users to search for images of text pages. For example, to search for the text image of FIG. 1 using the database of FIG. 4, the polygons of FIG. 2, which represent the text image, are compared against the three groups of polygons of the database. As shown in the figure, FIG. 2 matches the second group of polygons 210 of the database.

The main advantages of using the method of the present invention to search for text images is that this method does not require recognizing the text language. For example, the text of FIG. 1 can be in English, Chinese or Arabic where the polygons lines only depend on the start and end of each line of a paragraph. Accordingly, this method is much more simple and faster in sorting and searching images, in comparison to other techniques or methods of currently available search engines. Moreover, since the method depends on the start and end of each text line, accordingly, the text's words do not have to be clear in the image, which facilitates the process of taking the text picture for the user.

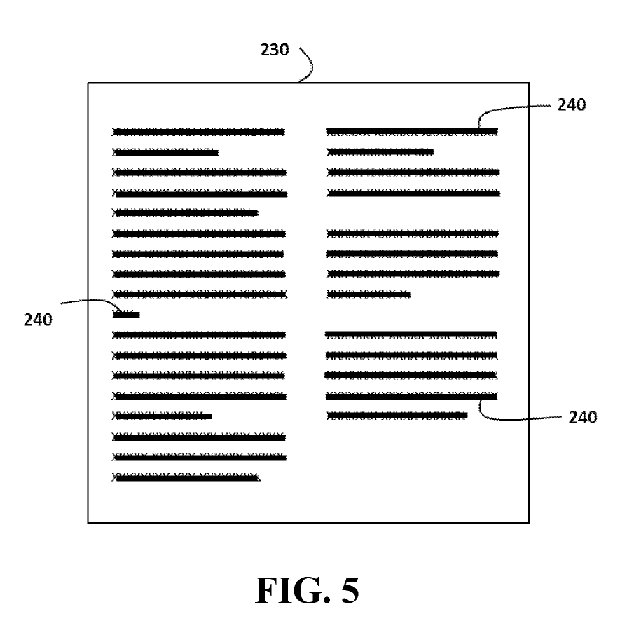

FIG. 5 illustrates marking each line of an image of the text page 230 with a strip 240. The strip starts and ends at the start and end of each line. The unique successive lengths of the strips of the page image are used to create a unique identifier representing the page image. The unique identifier is stored in a database that associates each page image with a unique identifier and related information. Searching this database with a text image allows retrieving the related information associated with the text image in a simple manner. This method of using the lines strips does not depend on the language of the text, similar to using the method of the paragraphs polygons.

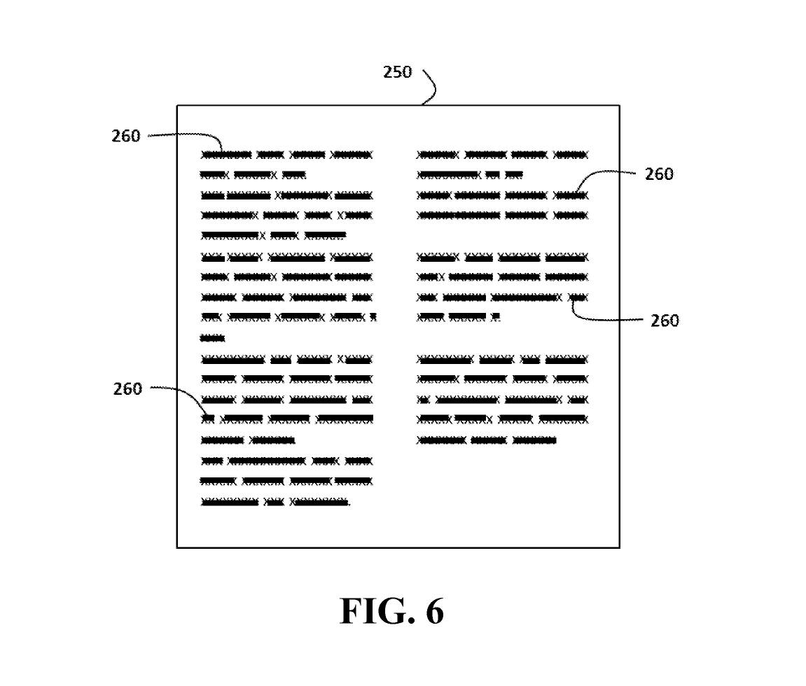

FIG. 6 illustrates marking each word in the image of the text page 250 with a strip 260. The strip starts and ends at the start and end of each word, by detecting the space between each two successive words. The unique successive lengths of the strips of the page image are used to create a unique identifier representing the page image. The unique identifier is stored in a database that associates each page image with a unique identifier and related information. Searching this database with a text image allows retrieving the related information associated with the text image in a simple manner. This method of using the words strips does not depend on the language of the text, similar to using the method of the paragraphs polygons.

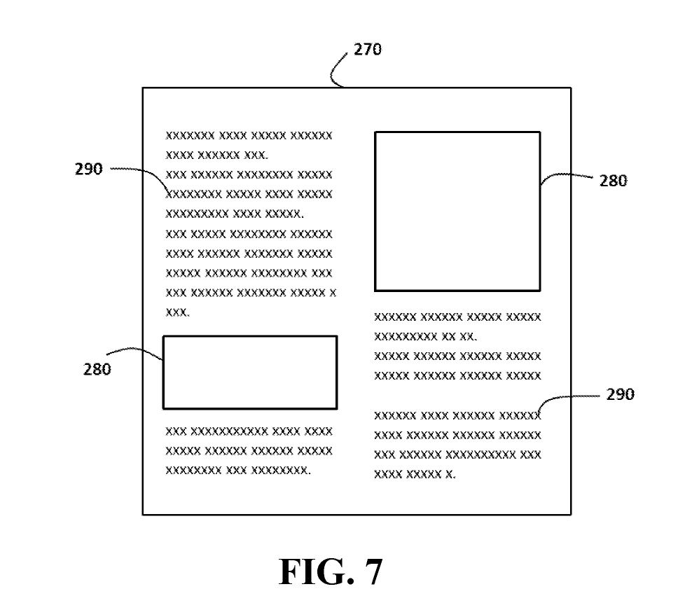

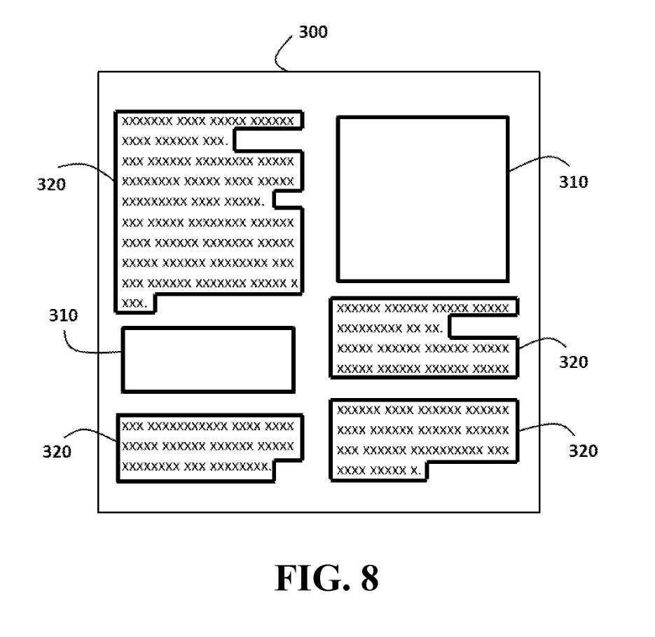

FIG. 7 illustrates another example of a page image 270 including pictures 280 and text 290. FIG. 8 illustrates the image of the page 300 after marking each picture's outlines with a polygon 310 and also marking each paragraph outlines with a polygon 320. The unique shape of the entire polygons allows for efficiently sorting and searching the page images that include pictures and text in a simple and fast manner. This is achieved by storing each group of polygons of a page image in a database that associates the page image with its group of polygons and related information. The related information can be pictures, videos, documents or the like, as will be described subsequently.

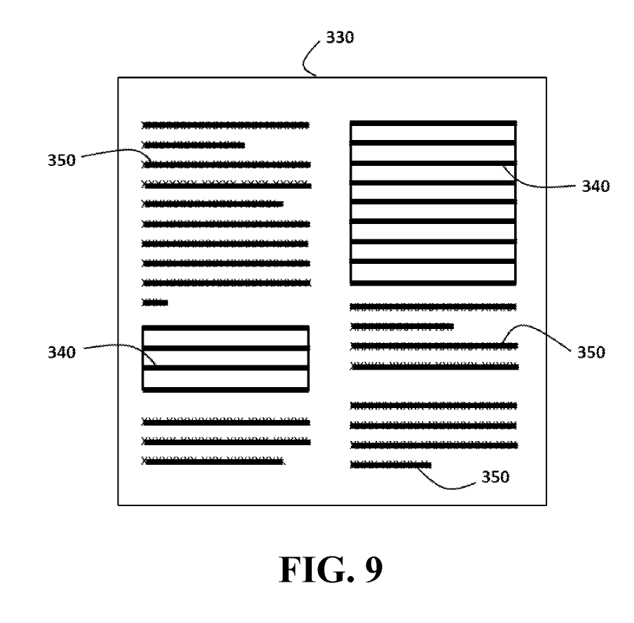

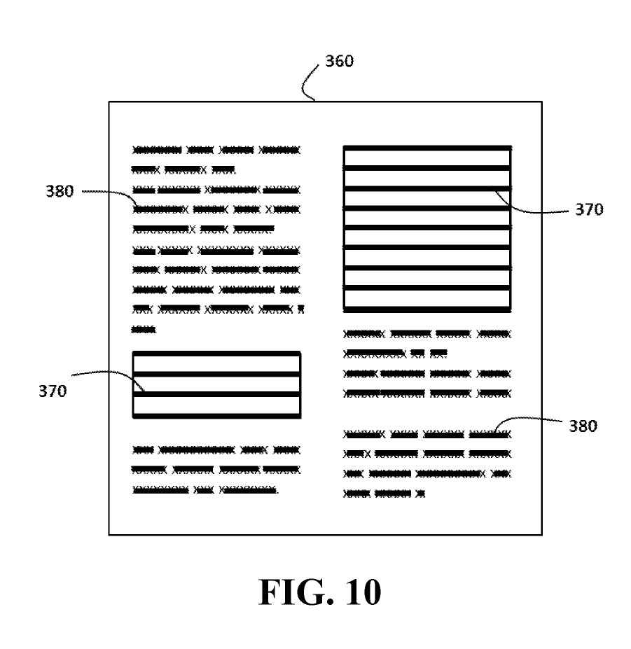

FIG. 9 illustrates using the strips instead of the polygons to mark the text and pictures of the page image 330 of the previous example. As shown in the figure, the strips 340 mark the start and end of each text line and the start and end of each picture sides. FIG. 10 illustrates replacing the strip of each text line with a plurality of strips located on each word of the text line. Generally, the polygons and strips can be used combined or separated for the same page image that contains text and/or pictures.

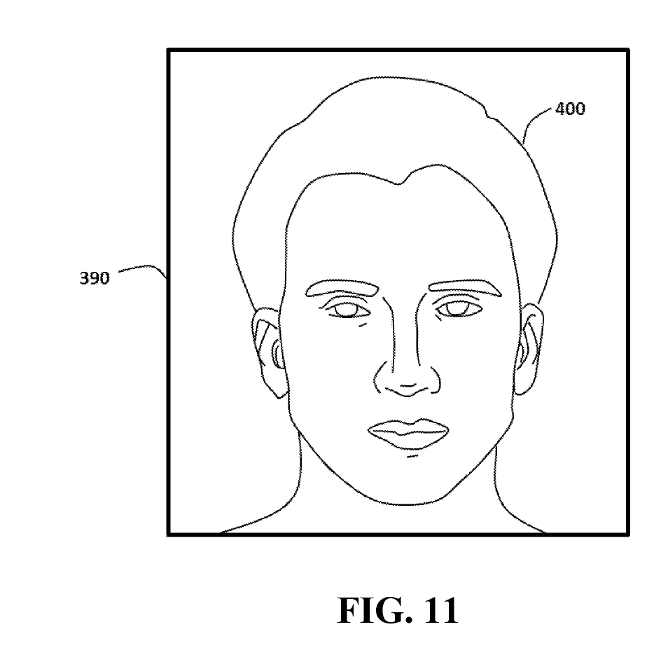

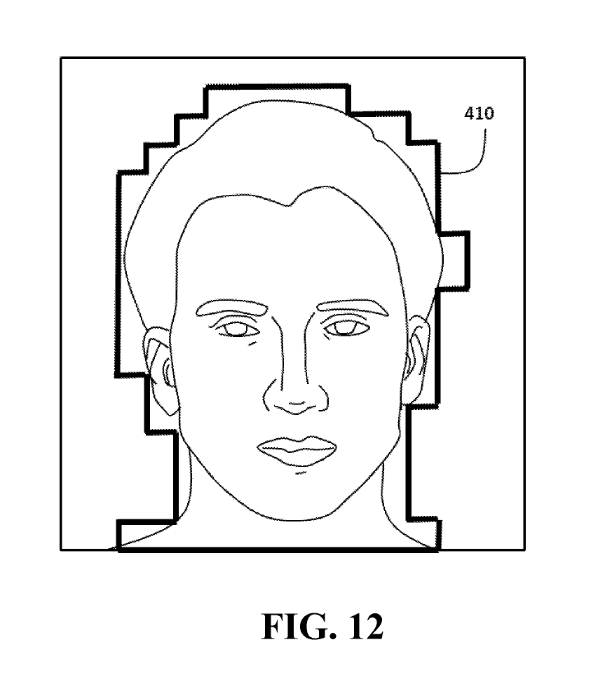

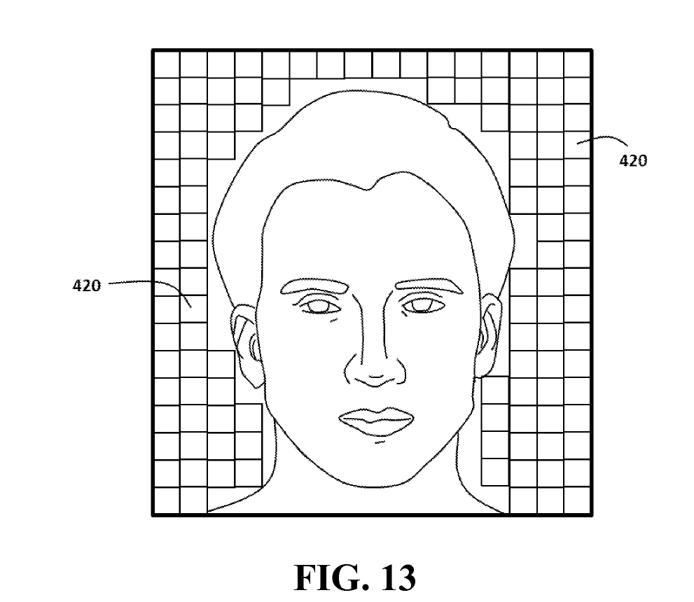

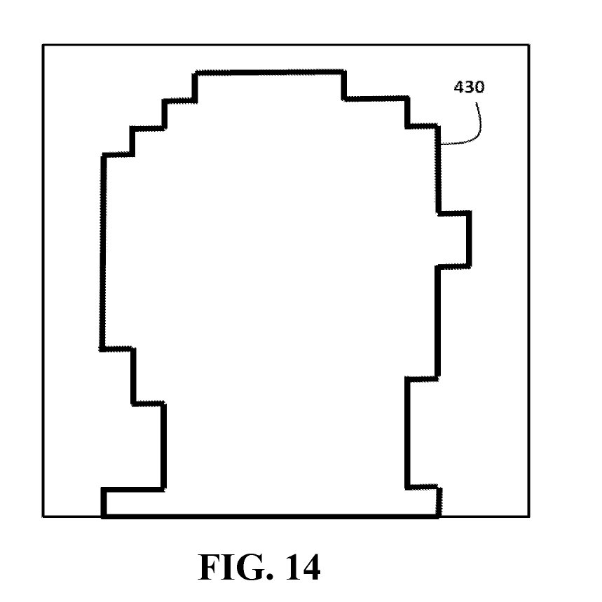

FIG. 11 illustrates a picture 390 of a face 400. FIG. 12 illustrates outlining the face with a polygon 410 using the squares grid 420 of FIG. 13. FIG. 14 illustrates the polygon 430 without the face; where using this polygon allows sorting and searching images that include faces. This method functions well if the face picture is not clear or if it is missing some of its parts, which will be described subsequently.

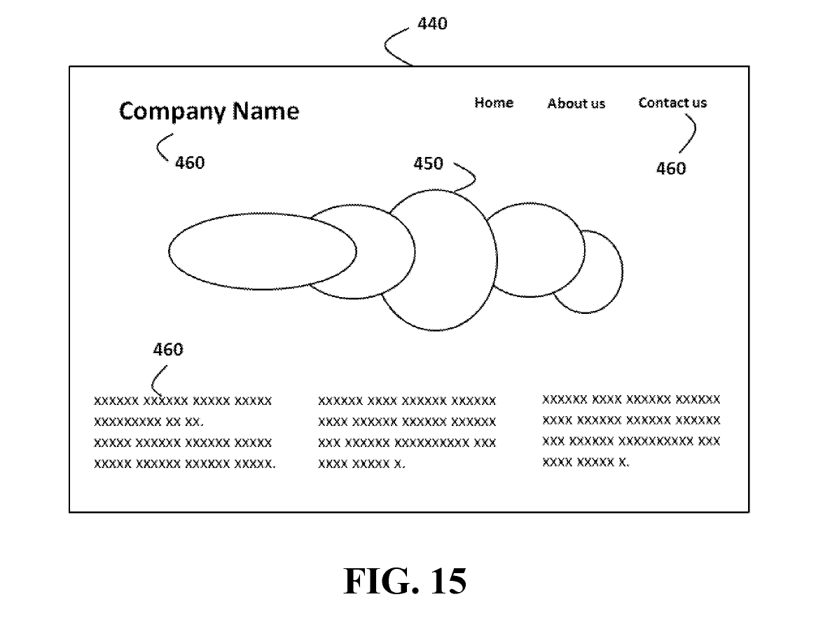

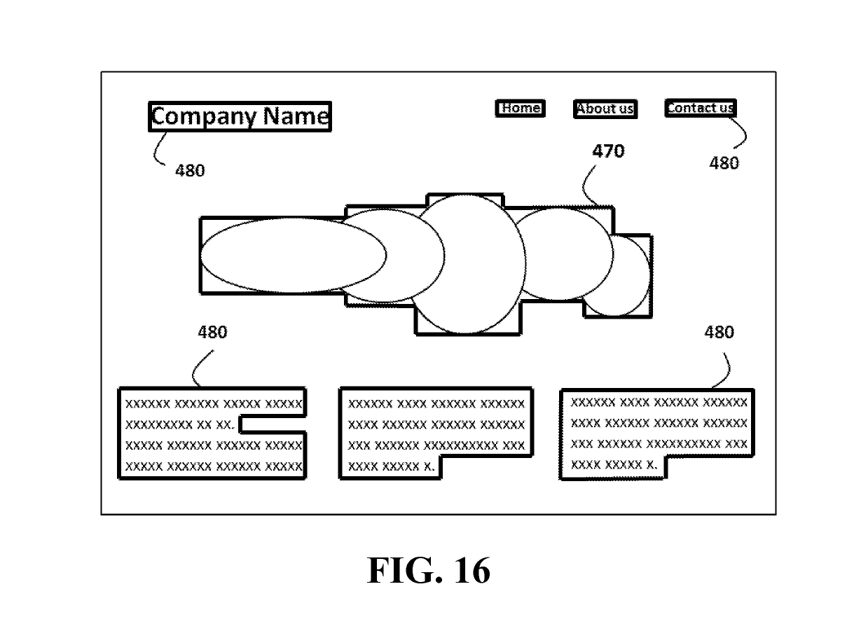

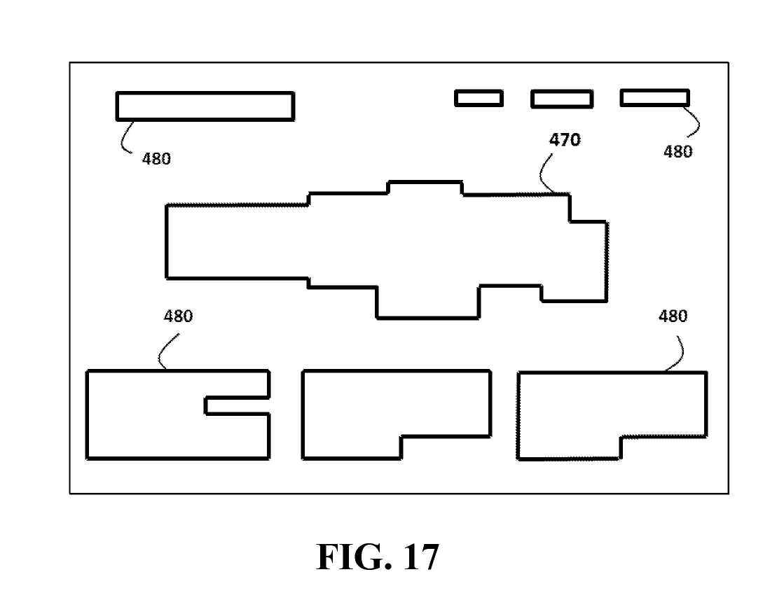

FIG. 15 illustrates a screenshot 440 of a Web page including a picture 450 and text 460. FIG. 16 illustrates using a polygon 470 to mark the outlines of the picture and using a plurality of polygons 480 to mark the text outlines of the separate paragraphs. FIG. 17 illustrates the entire polygons of the screenshot. Using these entire polygons allows sorting and searching the images of Web pages in a simple manner. One of the advantages of using this method with Web pages is each time a user scrolls up/down or zooms in/out the Web page, the present invention recognizes what is exactly presented on the computer display. However, using the present invention with the screenshot or image or a Web pages allows detecting the URL of the Web page, in the case of it being unknown.

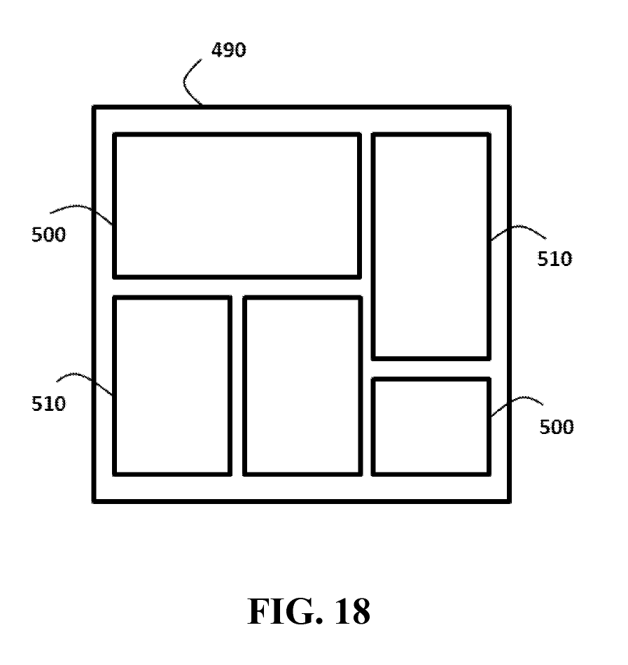

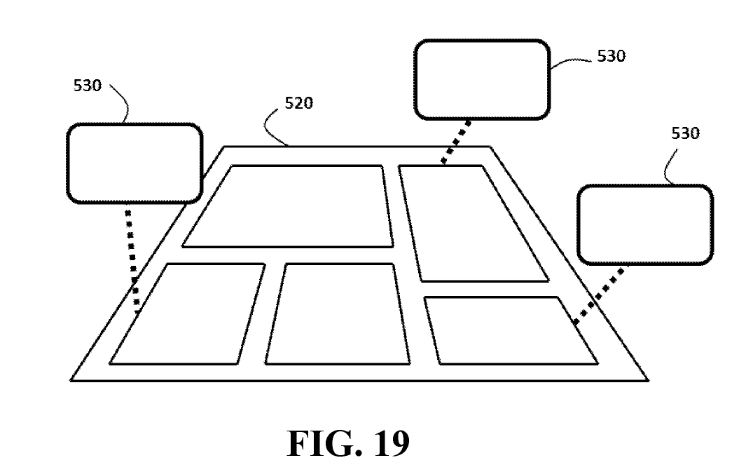

Using the present invention allows software developers to create numerous innovative augmented reality applications. For example, FIG. 18 illustrates a page 490 of a magazine which includes pictures 500 and paragraphs of text 510. FIG. 19 illustrates positioning the magazine page 520 horizontally on a desk, and using a mobile phone or tablet camera to view the magazine page. As shown in the figure, digital data 530 appears on the mobile phone or tablet display linking to some pictures or paragraphs of the magazine page. This digital data can be videos, pictures or digital text related to the content of the linked pictures or paragraphs.

In such augmented reality application, the present invention does not need to recognize the content of the magazine page, because detecting the outlines of the content is enough. This is achieved by using a computer vision program, as known in the art. However, such augmented reality application is perfect for newspapers and magazines publisher, for it allows them to add more digital information to their publications. Each page of a newspaper or magazine is scanned in order for it to be converted into groups of polygons or strips to be stored in online database. The online database associates each article of a newspaper or magazine with a related data that appears to the user when they view the article with a mobile phone or tablet camera.

If a user is viewing an older issue of a magazine, the user may first use the camera to capture the cover of the magazine, after which they can capture the pages of the magazine. Viewing the cover of the magazine with the camera lets the present invention locate the exact issue of the magazine in the database. Viewing the pages of the magazines with the camera allows the present invention to locate the viewed page in the database of the exact issue of the magazine.

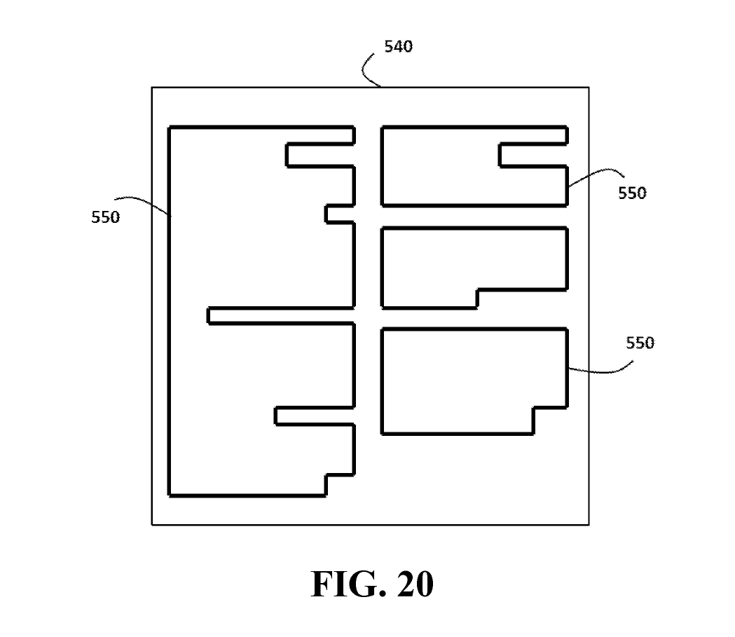

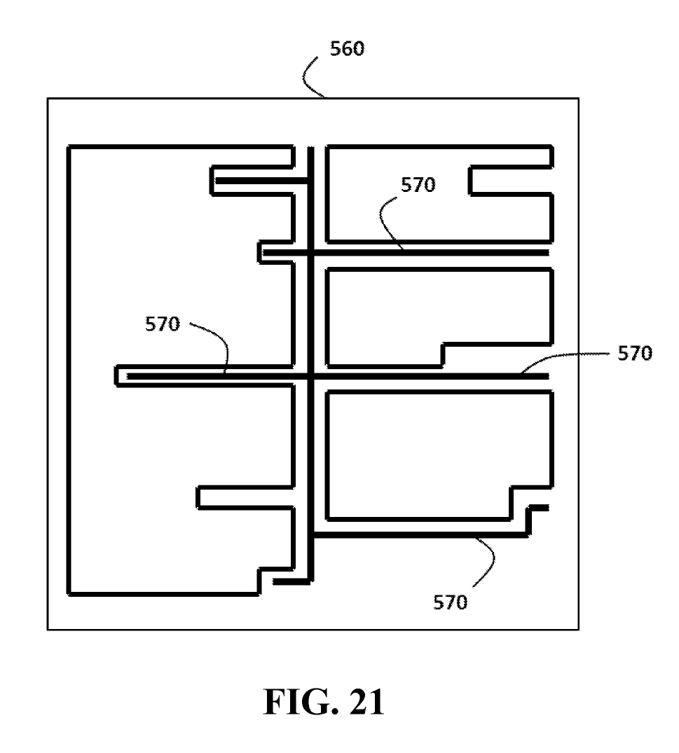

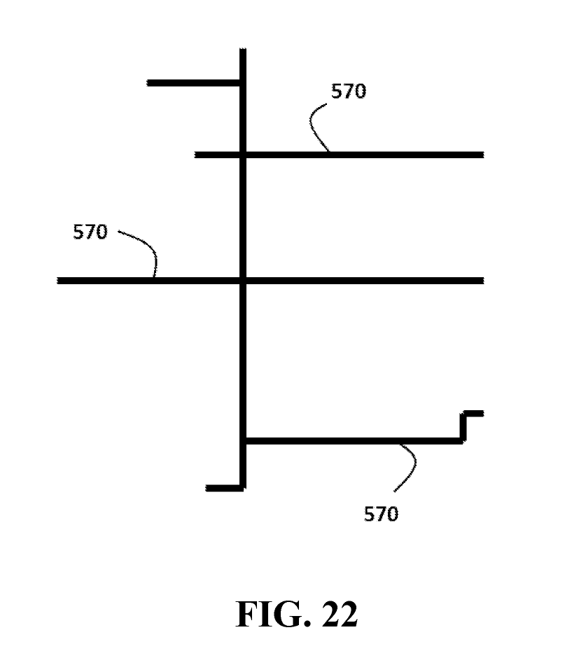

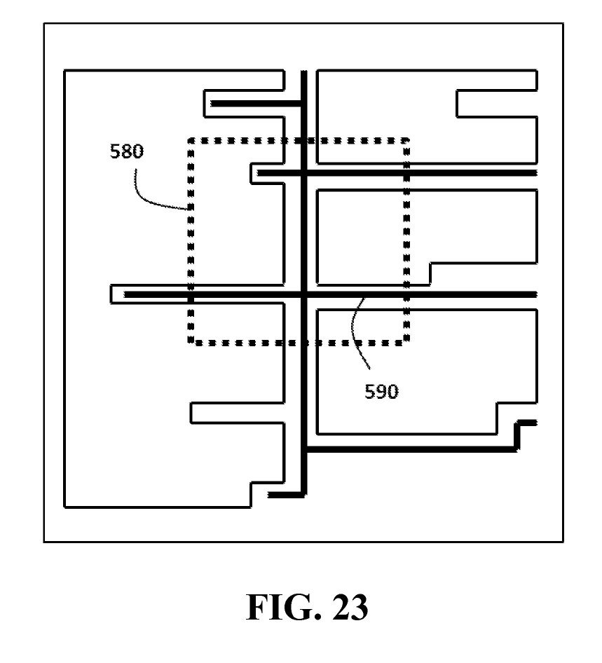

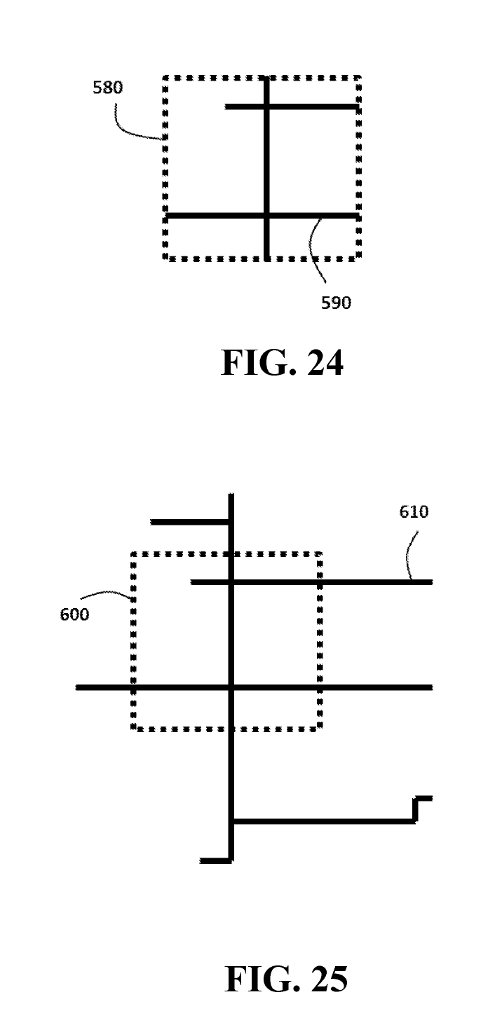

In one embodiment, the present invention can let a user locate an image in a database using just one part of the image. For example, FIG. 20 illustrates a page image 540 where the entire polygons 550 of the page are marked. FIG. 21 illustrates the page image 560 after the spaces between the polygons are marked with strips 570. FIG. 22 illustrates the strips 560 without the polygons. Such strips are stored in the database associated with the polygons of the page. FIG. 23 illustrates a part of the image defined by the rectangle 580 which partially cuts the strips 590. FIG. 24 illustrates the image part 580 with its partial strips 590. To search for the image in the database using this image part, the partial strips are compared relatively to the strips of all the images stored in the database. Once the partial strips match a part from strips of an image, this image is retrieved from the database as a search result. FIG. 25 illustrates how the partial strips of the image part 600 match the strips 610 of the image.

In one embodiment, the search method of the present invention can be to learn about products in supermarkets or shopping centers. In such cases, using the mobile phone camera to view a product box allows digital data related to the product to appear on the mobile phone display as an augmented reality application. This is achieved by converting the text or pictures located on the product box into polygons or strips, as it was described previously. The user can then write a comment or review about the product using the mobile phone keyboard, where this comment or review appears to other users who are viewing the same product box on their mobile phone's display.

In another embodiment, the present invention is used with street advertisements to provide additional information about the products or services that appear in the advertisement. In this case, using the mobile phone camera to view a street advertisement allows digital data which is related to the viewed advertisement, then it appears on the mobile phone display as an augmented reality application. In this case too, the user can write a comment or review about the product or service of the advertisement, where this comment or review appears to other users who are viewing the same advertisement on their mobile phones display.

In another embodiment, the present invention is used to search videos using a picture of a frame of the video. In a case as such, the content or objects which appear in each video frame are converted into polygons and stored in a database that associates each video with a plurality of polygons. Once a user is searching this database using a picture of a video frame, this frame is converted into polygons to be compared with polygons of the entire database. Such utilization of the present invention is greatly useful for online videos websites such as YOUTUBE. However, in such cases, the search result indicates the video of the search image and the frame time of the search image in the video.

Using the present invention lets the users search through files on personal computers using just a picture or a screenshot of a file. For example, a user can search through files of MICROSOFT POWERPOINT Applications using a screenshot of a slide from a POWERPOINT file. This ability is not possible nor available when using current available search engines. However, in this case the present invention converts every slide of the POWERPOINT application into groups of polygons and then stores these associated polygons with the name of the file. The same process can be utilized with other software or desktop applications.

The previous descriptions and examples illustrate the use of the present invention with two-dimensional images or pictures. However, the present invention is also utilized with three-dimensional objects or models. For example, to recognize the identity of a human's head from different points of view, the pictures of the human's head are taken from different angles. Each and every one of these pictures are converted into a polygon, as previously described. The polygons of all pictures of the same human's head are then associated with a unique ID to be stored in a database. This unique ID represents the identity of the human's head. Once the database is searched with a picture of the human's head, the Identity of this person is then detected. Accordingly, it is possible to detect the identity of people using a picture of the back or side angle of the head without needing to show their faces within the pictures.

The same process of the present invention can be used with three-dimensional objects such as buildings, vehicles or machines. In such cases as a 3D model of the building, vehicle or machine; it is then used to take different pictures of them using the virtual camera of a computer. Each picture taken by the virtual camera is converted into a polygon to be associated with an ID representing the object and then stored in a database.

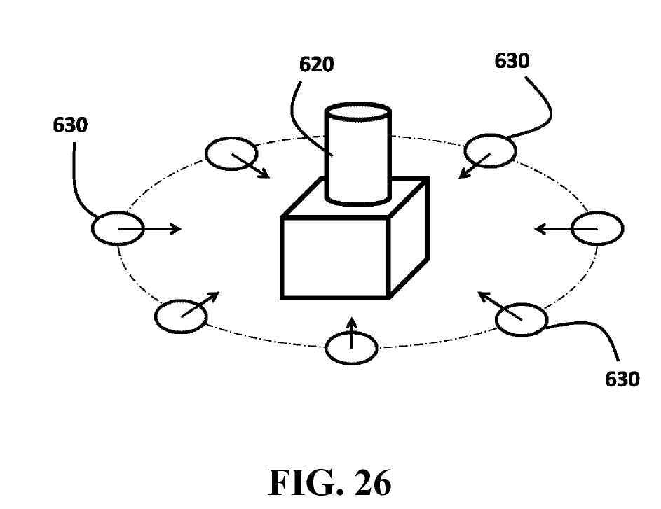

FIG. 26 illustrates a 3D model 620 positioned in three dimensions on a computer display, where the spots 630 represent the positions of the computer virtual camera taking pictures of the 3D models from different points of view. The same result can be achieved by horizontally rotating the 3D model in a 360 degrees on the computer screen, and taking a picture for the 3D model from each different horizontal rotation. It is also possible to vertically rotate the 3D model in a 360 degrees, and take a picture of the 3D model from each different vertical rotation. This way the 3D model can be recognized from any different point of view.

Finally, to check the polygons of a search image against the polygons stored in a database, the polygons shapes of the search image is geometrically compared relative to the shapes of the stored polygons. In case of using the strips technique, the pattern of the strips lengths of the search images is compared against the pattern of the strips lengths stored in the database. Such geometrical or mathematical comparison is much simpler and faster than comparing the pixels of the search images against the images stored in the database, as other visual search engines function.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A visual search method of a text image comprising:
marking the text image with successive strips each of which starts and ends at the start and end of a text line of the text image;
creating a set of numerals representing the lengths of the successive strips; and
comparing the set of numerals against a database that associates each unique set of numerals with related information and an identifier representing the text source.

2. The visual search method of claim 1 wherein each strip of the successive strips starts and ends at the start and end of a text word of the text image.

3. The visual search method of claim 1 wherein each strip of the successive strips is a polygon that covers the boundary lines of a paragraph of the text image.

4. The visual search method of claim 1 further the text image includes pictures and a plurality of the successive strips start and end at the sides of the pictures.

5. The visual search method of claim 1 wherein the related information is digital data such as text, pictures, videos, or documents.

6. The visual search method of claim 1 wherein the text source is a book, magazine, newspaper, or Web page.

7. The visual search method of claim 1 wherein the text source is a box of a product and the additional information is related to the product.

8. The visual search method of claim 1 wherein the text source is a street advertisement and the additional information is related to content, product or service of the street advertisement.

9. The visual search method of claim 1 wherein the text source is a computer application.

10. The visual search method of claim 1 further a user can provide the database with comments when viewing the related information wherein the comments can be accessible to other users when viewing the related information.

11. The visual search method of claim 1 wherein an electronic device equipped with a camera and display is utilized to take the picture of the text and present the related information on the display.

12. The visual search method of claim 1 wherein the set of numerals represents a part of the successive strips of the text image.

13. A visual search method of a virtual 3D model comprising:
capturing pictures of the virtual 3D model from different points of view;
generating a set of polygons each of which represents the boundary lines of the virtual 3D model that appear in a single picture of the pictures;
comparing the set of polygons against a database that associates each unique set of polygons with related information and an identifier representing the virtual 3D model.

14. The visual search method of claim 13 wherein the pictures are captured by the virtual camera of a computer.

15. The visual search method of claim 13 wherein the pictures are captured when horizontally or vertically rotating the virtual 3D model on a computer display.

16. The visual search method of claim 13 wherein the virtual 3D model represents a human's head, building, vehicle, machines, or other objects.

17. A visual search method of an object picture comprising:
marking the boundary lines of the object that appear in the picture with a polygon; and
comparing the shape of the polygon with a database that associates each unique shape of a polygon with related information and an identifier representing the name of the object.

18. The visual search method of claim 17 wherein an electronic device equipped with a camera and display is utilized to take the picture of the object and present the related information on the display.

19. The visual search method of claim 17 further the object is a plurality of objects appears in a video and the object picture is a frame of the video and the related information includes the location of the video and the time of the frame when playing the video.

20. The visual search method of claim 17 wherein the object is a human's face.
